(19) United States
(12) Patent Application Publication
(10) Pub. No.: US 2021/0278315 A1
(43) Pub. Date: Sep. 9, 2021

(54) METHOD FOR DIAGNOSING WHEEL BEARING

(71) Applicant: ILJIN Global Co.,Ltd, Seoul (KR)

(72) Inventor: Jong Keun LIM, Seoul (KR)

(73) Assignee: ILJIN Global Co.,Ltd, Seoul (KR)

(21) Appl. No.: 17/190,959

(22) Filed: Mar. 3, 2021

(30) Foreign Application Priority Data
Mar. 3, 2020 (KR) 10-2020-0026832

(51) Int. Cl. G01M 13/045; G01P 7/00; G01P 15/00

(52) U.S. Cl. CPC G01M 13/045; G01P 15/00; G01P 7/00

(57) ABSTRACT

There is provided a method for diagnosing the presence of failure or abnormal operation of a wheel bearing. The method includes detecting acceleration information by an acceleration sensor mounted to a rotational central axis of the wheel bearing or at a position radially spaced apart from the rotational central axis and configured to rotate together with the wheel bearing; calculating speed information based on the acceleration information detected by the acceleration sensor; and diagnosing the wheel bearing based on the acceleration information detected by the acceleration sensor and the speed information calculated from the acceleration information. In the acceleration detection step, the acceleration sensor collects the acceleration information in at least one of a first direction extending radially from the rotational central axis of the wheel bearing and a second direction perpendicular to the first direction on a plane perpendicular to the rotational central axis of the wheel bearing.

### CROSS-REFERENCE TO RELATED APPLICATIONS

This application claims priority to Korean Patent Application No. 10-2020-0026832 filed on Mar. 3, 2020, the entire contents of which are herein incorporated by reference.

### TECHNICAL FIELD

The present disclosure relates to a method for diagnosing the presence of failure or abnormal operation of a wheel bearing, more particularly, to a diagnosis method capable of performing a failure diagnosis for a wheel bearing with a simplified and reliable manner.

### BACKGROUND

A wheel bearing is a device for supporting a wheel of a vehicle while rotatably mounting the wheel to a vehicle body, and performs a function of connecting a rotating element to which the wheel is mounted to a non-rotating element fixed to the vehicle body through rolling elements such that the wheel mounted to the rotating element is rotatably supported to the vehicle body.

When a vehicle is travelling, a high load and moment may be applied to a wheel bearing in radial and axial directions. As a result, damage such as flaking may be generated on an outer ring, an inner ring, or the like that support the rolling elements, which may cause failure of the rings. Further, such damage may cause noise, vibration, heat generation, or the like, and in severe cases, may cause an accident in which the wheel bearing is stuck or separated from a driving shaft.

Since chassis components such as a wheel bearing did not have a diagnosis function of monitoring an operational state of the components, a driver or mechanic had to sense noise or vibration for himself (or herself) and had to intuitively determined abnormality in the chassis components.

However, there may be a large variation in such an intuitive determination depending on a level of skill of the driver or mechanic. This makes it difficult to ensure the reliability of the determination result. Accordingly, accurate failure diagnosis may not be performed.

In order to solve this problem, there has been proposed techniques for monitoring and diagnosing an operational state of chassis components including a wheel bearing by attaching a sensor to the wheel bearing or the like.

However, since failure diagnosis techniques known in the related art are configured to provide with an acceleration sensor and a wheel speed sensor mounted to or around a wheel bearing to diagnose an operational state of the wheel bearing. As a result, these wheel bearing diagnosing/monitoring techniques need to perform complex wiring operation in the interior of the vehicle such that signals from the sensors are in conjunction with each other. This causes a problem in that hardware and software structures inside the vehicle body are complicated and the manufacturing cost is increased.

### SUMMARY

The present disclosure is made in view of this problem, and an object of the present disclosure is to provide a method for diagnosing the failure of a wheel bearing in a simplified and reliable manner.

Representative configurations of the present disclosure for achieving the above object are as follows.

According to one embodiment of the present disclosure, there is provided a method for diagnosing the presence of failure or abnormal operation of a wheel bearing. The method according to one embodiment of the present disclosure may comprise: an acceleration detection step of detecting acceleration information by an acceleration sensor mounted to a rotational central axis of the wheel bearing or at a position radially spaced apart from the rotational central axis and configured to rotate together with the wheel bearing; a speed calculation step of calculating speed information based on the acceleration information detected by the acceleration sensor; and a diagnosis step of diagnosing the wheel bearing based on the acceleration information detected by the acceleration sensor and the speed information calculated from the acceleration information. According to one embodiment of the present disclosure, in the acceleration detection step, the acceleration sensor may be configured to collect the acceleration information in at least one of a first direction extending radially from the rotational central axis and a second direction perpendicular to the first direction on a plane perpendicular to the rotational central axis.

According to one embodiment of the present disclosure, the acceleration sensor may be configured to output the acceleration information in at least one of the first direction and the second direction as a sinusoidal signal according to the rotation of the wheel bearing.

According to one embodiment of the present disclosure, the speed information calculated based on the acceleration information from the acceleration sensor may be calculated in consideration of a time taken to form one-cycle of the sinusoidal signal outputted from the acceleration sensor.

According to one embodiment of the present disclosure, the method may further comprise a signal separation step of separating a signal of the acceleration information into a base signal and a vibration signal between the acceleration detection step and the speed calculation step.

According to one embodiment of the present disclosure, in the speed calculation step, the speed information may be calculated based on the base signal.

According to one embodiment of the present disclosure, in the diagnosis step, the diagnosis of the wheel bearing may be performed based on the vibration signal.

According to one embodiment of the present disclosure, the diagnosis step may be configured to determine that the failure or abnormal operation of the wheel bearing is present when a frequency band where a peak signal is generated in the vibration signal coincides with a defect frequency band calculated from the base signal.

According to one embodiment of the present disclosure, the method may further comprise a warning step of displaying the diagnosis result to the outside when it is determined that the failure or abnormal operation of the wheel bearing is present in the diagnosis step.

According to one embodiment of the present disclosure, the acceleration sensor may be configured to be detachably mounted to one side of a wheel mounted to the wheel bearing so as to detect the acceleration information.

According to one embodiment of the present disclosure, the acceleration sensor may be configured to be detachably mounted to a wheel bearing bolt or a wheel bearing nut, which is used to mount the wheel to the wheel bearing, so as to detect the acceleration information.

Further, the wheel bearing diagnosis method according to the present disclosure may further comprise other additional configurations without departing from the technical sprit of the present disclosure.

Since the wheel bearing diagnosis method according to one embodiment of the present disclosure is configured to diagnose the presence of failure or abnormal operation of a wheel bearing using only acceleration information detected by an acceleration sensor, it is not necessary to perform complicated wiring operation or the like for linking acceleration information from an acceleration sensor and speed information from a speed sensor inside the wheel bearing and the vehicle, thus simplifying structures of the wheel bearing and the vehicle and reducing the manufacturing cost.

Further, the wheel bearing diagnosis method according to one embodiment of the present disclosure is configured to collect acceleration information as a sinusoidal signal through an acceleration sensor which is mounted to one side of a wheel or a wheel bearing and rotates together with the wheel bearing, to calculate speed information in consideration of a cycle of the acceleration information of a sinusoidal signal, and to perform the failure diagnosis of the wheel bearing based on the detected acceleration information and the speed information calculated from the detected acceleration information. Thus, it is possible to calculate the speed information based on the acceleration information with a simple algorithm and perform the failure diagnosis of the wheel bearing based on the information. This makes it possible to further simplify software and hardware structures of the diagnosis device.

Further, since the wheel bearing diagnosis method according to one embodiment of the present disclosure is configured to detect acceleration information by an acceleration sensor which is rotated together with the wheel bearing, the acceleration sensor or the like may be detachably mounted at an arbitrary position on one side of a wheel (for example, a wheel mounting bolt, a wheel mounting nut, or the like) to perform the failure diagnosis or collect information (for example, acceleration information or the like) required for the failure diagnosis. This eliminates a need to provide a complicated device for diagnosing the presence of failure of the wheel bearing in the wheel bearing in advance at the time of manufacturing the wheel bearing. Thus, it is possible to reduce the manufacturing cost of the wheel bearing and improve a degree of freedom of design of the wheel bearing.

### BRIEF DESCRIPTION OF THE DRAWINGS

FIG. 1 exemplarily illustrates a state in which a diagnosis device according to one embodiment of the present disclosure is mounted to a wheel.

FIG. 2 exemplarily illustrates a state in which a diagnosis device according to one embodiment of the present disclosure is mounted to a wheel.

FIG. 3A is a conceptual view exemplarily illustrating a technical configuration of the diagnosis device according to one embodiment of the present disclosure.

FIG. 3B is a conceptual view exemplarily illustrating a technical configuration of the diagnosis device according to one embodiment of the present disclosure.

FIG. 4 exemplarily illustrates a state in which an acceleration sensor is mounted on one side of a wheel to detect acceleration information so as to perform a failure diagnosis for the wheel bearing according to one embodiment of the present disclosure.

FIG. 5 exemplarily illustrates acceleration information (an acceleration signal when a vehicle travels at a constant speed along a straight line) detected by the acceleration sensor illustrated in FIG. 4.

FIG. 6 exemplarily illustrates a process of separating a signal of acceleration information (acceleration signal) detected by the diagnosis device according to one embodiment of the present disclosure into a base signal and a vibration signal.

FIG. 7 exemplarily illustrates a diagnostic process which can be used to diagnose a wheel bearing according to one embodiment of the present disclosure.

### DETAILED DESCRIPTION

Hereinafter, preferred embodiments of the present disclosure will be described in detail with reference to the appended drawings to such an extent that the present disclosure can be readily practiced by one of ordinary skill in the art.

Detailed descriptions of parts irrelevant to the present disclosure will be omitted for the purpose of more clearly describing the present disclosure. Throughout the specification, the same components will be described using same reference numerals. In addition, the shapes and sizes of the respective components illustrated in the drawings are arbitrarily illustrated for the sake of convenience in explanation, and hence the present disclosure is not necessarily limited thereto. That is, it should be understood that specific shapes, configurations and characteristics described in the specification may be modified in various embodiments without departing from the spirit and scope of the prevent disclosure, and positions or arrangements of individual components may be modified without departing from the spirit and scope of the prevent disclosure. Therefore, detailed descriptions to be described below should be construed as non-limitative senses, and the scope of the prevent disclosure should be understood to include appended claims and their equivalents.

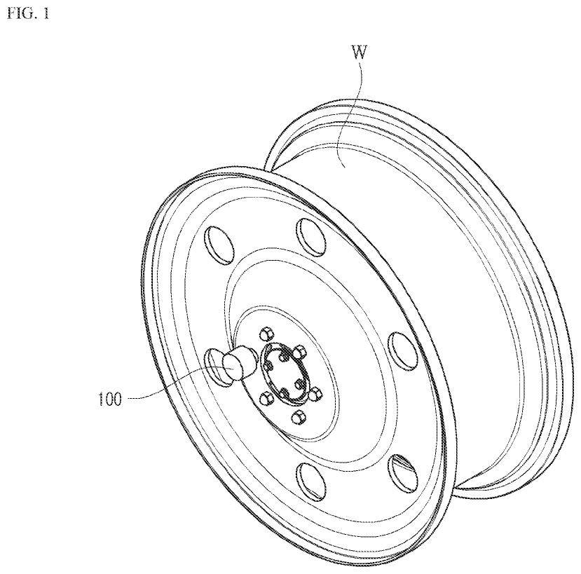

Referring to FIGS. 1 to 7, there are exemplarily illustrated a diagnosis device and a diagnosis method according to one embodiment of the present disclosure, and a wheel bearing provided therewith. As will be described below, the present disclosure is configured to detect acceleration information using an acceleration sensor, which is mounted on one side of the wheel bearing to rotate together with the wheel bearing; and subsequently, diagnose the presence of failure or abnormal operation of the wheel bearing using the detected acceleration information and speed information calculated based on the detected acceleration information.

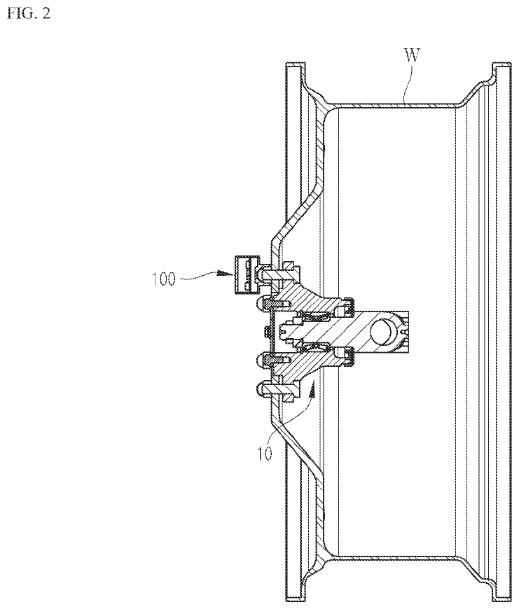

First, a structure of a wheel bearing 10 to which the diagnosis device and/or the diagnosis method according to one embodiment of the present disclosure can be applied will be described. As illustrated in FIGS. 1 and 2, the wheel bearing 10 may perform a function of connecting a rotating element to which a wheel is mounted and a non-rotating element connected to a vehicle body through rolling elements such that the wheel is rotatably supported to the vehicle body, similar to a conventional wheel bearing.

In the embodiment illustrated in the drawings, the structure of the wheel bearing is merely exemplarily illustrated to describe the diagnosis method for a wheel bearing according to one embodiment of the present disclosure. However, the diagnosis device and the diagnosis method according to one embodiment of the present disclosure, which will be described later, may be applied to wheel bearings having other various structures, in addition to the wheel bearing having the structure illustrated in the drawings.

When a vehicle is travelling, a high load and moment may be applied to a wheel bearing in radial and axial directions. Accordingly, an outer ring and an inner ring that support rolling elements may be damaged. Such damage may cause noise, vibration, heat generation, or the like, and in severe cases, may cause an accident in which the wheel bearing is stuck or separated from a driving shaft.

To prevent such a problem, the wheel bearing 10 according to one embodiment of the present disclosure may be configured to diagnose the presence of failure or abnormal operation of the wheel bearing 10 using a diagnosis device 100.

According to one embodiment of the present disclosure, the diagnosis device 100 may be mounted to one side of the wheel bearing 10 or a wheel W coupled to the wheel bearing 10 as illustrated in FIGS. 1 and 2, and may be configured to diagnose the presence of failure or abnormal operation of the wheel bearing 10 or detect information required for the failure diagnosis.

Specifically, the diagnosis device 100 may be configured to be mounted on a rotational central axis of the wheel bearing 10 or at a position spaced radially apart from the rotational central axis, and may be configured to detect acceleration information and/or perform the failure diagnosis while rotating together with the wheel bearing 10 and the wheel W mounted to the wheel bearing 10.

For example, the diagnosis device 100 according to one embodiment of the present disclosure may be detachably mounted to a wheel mounting bolt and/or a wheel mounting nut, which are (is) used to mount the wheel W to the wheel bearing 10, as illustrated in FIGS. 1 and 2, and may be configured to detect the acceleration information while rotating together with the wheel bearing.

In the embodiment illustrated in the drawings, the diagnosis device 100 is configured to be detachably mounted to one side of the wheel W coupled to the wheel bearing 10, but the diagnosis device 100 according to one embodiment of the present disclosure is not limited thereto. The diagnosis device 100 may be modified to have other various structures unlike the embodiment illustrated in the drawings as long as the acceleration information used in diagnosing the failure of the wheel bearing 10 can be detected by the acceleration sensor that rotates together with the wheel bearing 10. For example, the diagnosis device 100 according to one embodiment of the present disclosure may be configured to be mounted to the rotating element of the wheel bearing 10 instead of the wheel W, or may be fixedly mounted to the wheel bearing 10 or the wheel W.

According to one embodiment of the present disclosure, the diagnosis device 100 may comprise a sensing part 110 configured to detect information about an operation state of the vehicle (or an operation state of the wheel bearing) for diagnosing the presence of failure or abnormal operation of the wheel bearing 10. For example, the sensing part 110 of the diagnosis device 100 according to one embodiment of the present disclosure may be configured as an acceleration sensor which detects acceleration information that is generated when the wheel bearing 10 is operated.

According to one embodiment of the present disclosure, the sensing part 110 (acceleration sensor) may be provided in the diagnosis device 100 and may be configured to detect a vibration state of the wheel bearing 10 while rotating together with the wheel bearing 10 according to the rotation of the wheel bearing 10. The sensing part 110 may be configured as a one-axis acceleration sensor capable of measuring acceleration in one of x, y, and z-axis directions perpendicular to each another, a two-axis acceleration sensor capable of measuring acceleration in two directions of the x, y, and z-axis directions, a three-axis acceleration sensor capable of measuring acceleration in all the x, y, and z-axis directions, or the like.

According to one embodiment of the present disclosure, the diagnosis device 100 may further comprise a diagnosis part 120 for diagnosing the presence of failure or abnormal operation of the wheel bearing 10; a storage part 130 for storing the acceleration information detected by the sensing part 110, the diagnosis result of the wheel bearing obtained at the diagnosis part 120, and the like; a display part 140 for displaying the diagnosis result to outside, and the like.

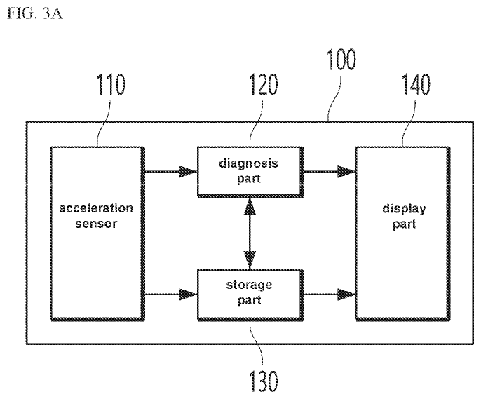

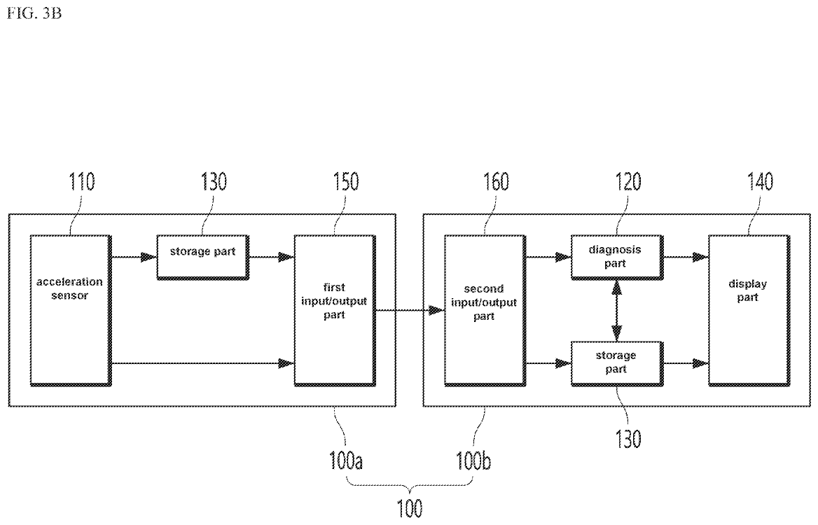

Referring to FIGS. 3A and 3B, there is exemplarily illustrated a configuration of the diagnosis device 100 according to one embodiment of the present disclosure. As illustrated in FIG. 3A, the diagnosis device 100 according to one embodiment of the present disclosure may have a single integral configuration in which both the sensing part 110 and the diagnosis part 120 are provided in one device. Alternatively, as illustrated in FIG. 3B, the diagnosis device 100 may have a divided configuration in which a sensing device 100a including the sensing part 110 and a diagnosis device 100b including the diagnosis part 120 are separately provided.

For example, in the case in which the diagnosis device 100 according to one embodiment of the present disclosure has the single integral configuration as illustrated in FIG. 3A, components such as the sensing part 110, the diagnosis part 120, the storage part 130, the display part 140 and the like may be configured to be provided in a single housing.

Meanwhile, in the case in which the diagnosis device 100 according to one embodiment of the present disclosure has the divided configuration in which the sensing device 100a for detecting the acceleration information (acceleration signal) and the diagnosis device 100b for diagnosing the presence of failure or abnormal operation of the wheel bearing are separately provided as illustrated in FIG. 3B, the sensing device 100a may be configured to comprise the sensing part 110 (acceleration sensor) for detecting the acceleration information, the storage part 130 for storing the acceleration information detected by the sensing part 110, an input/output part (e.g., a first input/output part 150) for transferring the detected acceleration information to the diagnosis device 100b, and the like, and the diagnosis device 100b may be configured to comprise an input/output part (e.g., a second input/output part 160) for receiving the acceleration information detected by the sensing part 110, a diagnosis part 120 for diagnosing the wheel bearing or the like based on signal information (for example, the acceleration information) transmitted through the input/output part, the storage part 130 for storing reference data, diagnosis/analysis results or the like, the display part 140 for outputting and displaying the diagnosis result provided from the storage part 130.

The configurations of the diagnosis device 100 illustrated in FIGS. 3A and 3B are merely examples, and the diagnosis device 100 according to one embodiment of the present disclosure may further comprise additional configurations in addition to the configurations illustrated in FIGS. 3A and 3B. Further, the diagnosis device 100 according to one embodiment of the present disclosure may be implemented in a state that some parts are omitted.

Further, the diagnosis device 100 according to one embodiment of the present disclosure may be configured to calculate speed information based on the acceleration information detected by the acceleration sensor of the sensing part 110, and diagnose the presence of failure or abnormal operation of the wheel bearing using both the acceleration information detected by the acceleration sensor and the speed information calculated from the acceleration information.

In general, a defect frequency of the wheel bearing varies depending on a speed. Therefore, in order to accurately diagnose the presence of failure or abnormal operation of the wheel bearing or the like, not only the acceleration information but also the speed information need to be considered.

For example, the defect frequency of the inner ring, the outer ring, the rolling elements and the like, which constitute the wheel bearing, varies depending on a rotational frequency associated with a rotational speed, as follows.

Inner ring:

$$f i = \frac{fr}{2} Z ( 1 + \frac{d}{D} cos α )$$

Outer ring:

$$fo = \frac{fr}{2} Z ( 1 - \frac{d}{D} cos α )$$

Rolling element:

$$fb = \frac{fr}{2} \frac{D}{d} [ 1 - {( \frac{d}{D} cos α )}^{2} ]$$

[Where fi represents the defect frequency of the inner ring, fo represents the defect frequency of the outer ring, fb represents the defect frequency of the rolling elements, fr represents the rotational frequency of a shaft, Z represents the number of rolling elements, d represents the diameter of the rolling elements, D represents a pitch diameter of the rolling elements, and a represents the contact angle of the rolling elements.]

Accordingly, the diagnosis device 100 according to one embodiment of the present disclosure may be configured to diagnose the wheel bearing for performing a more reliable diagnosis by calculating the speed information based on the acceleration information detected by the acceleration sensor and then taking into account both the detected acceleration information and the speed information calculated from the detected acceleration information.

For example, the diagnosis device 100 according to one embodiment of the present disclosure may be configured to calculate and use the speed information from the acceleration information detected by the acceleration sensor in a below-described manner.

First, as described above, the diagnosis device 100 according to one embodiment of the present disclosure may be mounted to the rotational central axis of the wheel bearing 10 or at a position radially spaced apart from the rotational central axis, and may be configured to detect the acceleration information while rotating together with the wheel bearing 10 according to the rotation of the wheel bearing 10.

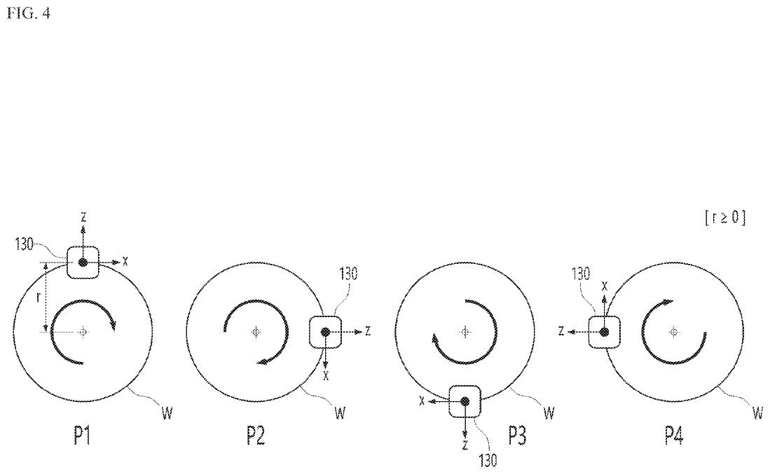

When the sensing part 110 (acceleration sensor) is configured to detect the acceleration information while rotating together with the wheel bearing 10 as described above, assuming that acceleration is detected by the acceleration sensor in a first direction (z-axis direction illustrated in FIG. 4) extending radially from the rotational central axis of the wheel bearing 10, a second direction (x-axis direction illustrated in FIG. 4) perpendicular to the first direction on a plane perpendicular to the rotational central axis, and a third direction (y-axis direction illustrated in FIG. 4; e.g., vehicle axis direction) perpendicular to the first direction and the second direction, acceleration signals in the first direction and the second direction are outputted as a substantially sinusoidal signal while the acceleration of gravity applied to the acceleration sensor changed according to the rotation of the wheel bearing 10, and acceleration signal in the third direction is outputted regardless of the acceleration of gravity.

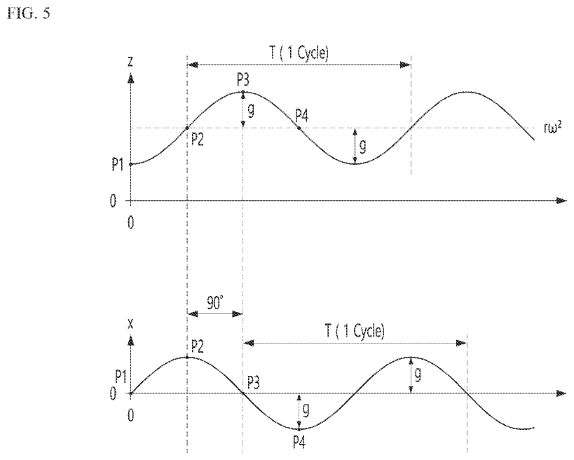

For example, assuming that the vehicle is traveling at a constant speed along a straight line, in the acceleration sensor that detects the acceleration in the first direction (z-axis direction illustrated in FIG. 4), the maximum level of acceleration of gravity in a negative direction is applied to the acceleration sensor positioned at a P1 position in FIG. 4, the maximum level of acceleration of gravity in a positive direction is applied to the acceleration sensor located at a P3 position in FIG. 4, and the acceleration of gravity of zero is applied to the acceleration sensor located at P2 and P4 positions in FIG. 4. In this manner, the acceleration of gravity is applied to the acceleration sensor while being changed depending on the position of the acceleration sensor. As a result, the acceleration signal is outputted as the sinusoidal signal as illustrated in FIG. 5.

On the other hand, in the acceleration sensor that detects the acceleration in the second direction (the x-axis direction illustrated in FIG. 4), the acceleration of gravity is not applied to the acceleration sensor positioned at the P1 and P3 positions in FIG. 4, the maximum level of acceleration of gravity in the positive direction is applied to the acceleration sensor positioned at the P2 position in FIG. 4 and the maximum level of acceleration of gravity in the negative direction is applied to the acceleration sensor positioned at the P4 position in FIG. 4. In this manner, the acceleration of gravity is applied to the acceleration sensor while being changed depending on the position of the acceleration sensor. As a result, the acceleration signal is outputted as the sinusoidal signal as illustrated in FIG. 5. Such an acceleration signal has a phase difference of 90 degrees with respect to the above-described acceleration signal in the first direction.

In contrast, the acceleration sensor that detects acceleration in the third direction (for example, the vehicle axis direction) is not affected by the acceleration of gravity at any position. Thus, in the state in which the vehicle is travelling at a constant speed along a straight line, the acceleration signal of zero is outputted.

Accordingly, when the acceleration sensor constituting the sensing part 110 of the diagnosis device 100 is configured to measure the acceleration in the first direction (z-axis direction illustrated in FIG. 4) extending from the rotational central axis of the wheel bearing 10 (the central axis of the wheel) and/or in the second direction (x-axis direction illustrated in FIG. 4) perpendicular to the first direction on the plane perpendicular to the rotational central axis, the acceleration signal of the sinusoidal signal as illustrated in FIG. 5 can be obtained from the acceleration sensor. In such an acceleration signal, one cycle of the sinusoidal signal means one rotation of the wheel bearing 10 and the wheel W. Thus, by calculating the amount of movement per unit hour in consideration of a time T taken for the one rotation, the mounting position (a radial distance from the central axis, or the like) of the acceleration sensor, and the like, it is possible to calculate the rotational speed of the wheel bearing 10 and/or the driving speed of the vehicle.

To do this, in the diagnosis device 100 according to one embodiment of the present disclosure, the acceleration sensor provided in the sensing part 110 may be configured to detect the acceleration in at least one of the first direction (the z-axis direction illustrated in FIG. 4) extending radially from the rotational central axis of the wheel bearing 10 and the second direction (the x-axis direction illustrated in FIG. 4) perpendicular to the first direction on the plane perpendicular to the rotational central axis.

The diagnosis device 100 according to one embodiment of the present disclosure is capable of performing the speed information calculation and the failure diagnosis by detecting the acceleration signal in any one of the first direction and the second direction described above. However, when the diagnosis device 100 according to one embodiment of the present disclosure is configured to measure and use the acceleration signal in each of the first direction and the second direction, it is possible to perform the speed information calculation and the failure diagnosis while comparing the detected acceleration signals with each other, which may be more advantageous for reliable failure diagnosis.

For example, in the diagnosis device 100 according to one embodiment of the present disclosure, the acceleration sensor provided in the sensing part 110 may be configured as a three-axis MEMS acceleration sensor or the like that can measure acceleration in all of the first direction (the direction extending radially from the rotational central axis of the wheel bearing 10), the second direction (the direction perpendicular to the first direction on the plane perpendicular to the rotational central axis), and the third direction (the direction perpendicular to both the first direction and the second direction; the vehicle axial direction).

On the other hand, the acceleration information detected during the traveling of the vehicle may be outputted as a mixture of an acceleration signal (a base signal) corresponding to the rotational speed of the wheel bearing and an acceleration signal (a vibration signal) generated by internal and external factors of the vehicle.

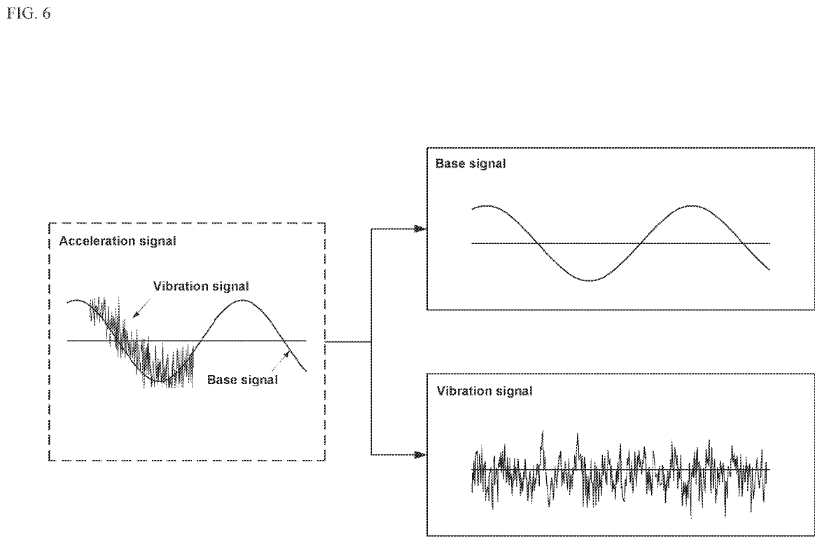

Accordingly, in order to perform a more simple and reliable speed calculation and failure diagnosis, the diagnosis device and the diagnosis method according to one embodiment of the present disclosure may be configured to separate the signal of the acceleration signal detected by the acceleration sensor into the base signal outputted in accordance with the rotational speed of the wheel bearing and the vibration signal generated by components of the wheel bearing or the internal and external factors of the vehicle (see FIG. 6), and then performing the speed calculation and the failure diagnosis.

For example, the base signal extracted from the acceleration signal may be used to calculate the rotational speed of the wheel bearing and/or the driving speed of the vehicle according to the above-described speed calculation method, and the vibration signal may be used as basic data for determining the presence or absence of failure of each component (for example, the inner ring, the outer ring, the rolling elements, and the like) of the wheel bearing through frequency analysis (e.g., FFT analysis) and the like.

As described above, the diagnosis device 100 according to one embodiment of the present disclosure is configured to calculate the speed information based on the acceleration information detected by the acceleration sensor of the sensing part 110 and perform the failure diagnosis of the wheel bearing based on the detected acceleration information and the speed information calculated therefrom. Accordingly, it is possible to smoothly diagnose the operational state of the wheel bearing without separately receiving speed information from the wheel speed sensor or the like. This eliminates a need to provide a diagnosis device having a complex structure in the wheel bearing or in the vicinity of the wheel bearing, which has been required in the related art. Thus, it is possible to further simplify the structure of the diagnosis device and the wheel bearing and reduce the manufacturing cost.

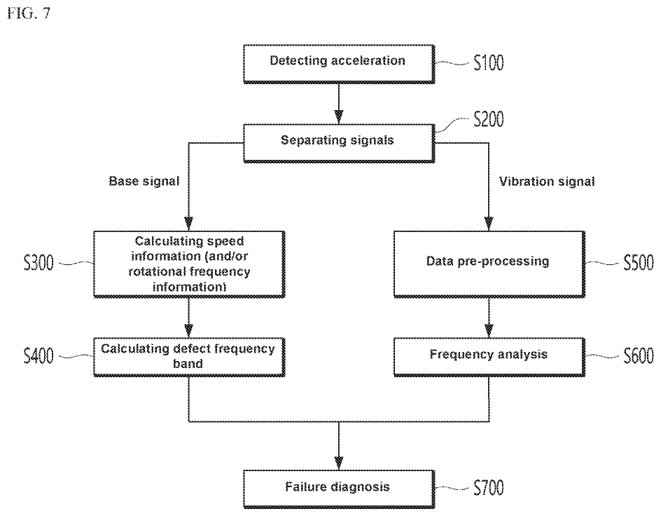

Referring to FIG. 7, there is exemplarily illustrated a diagnosis process of diagnosing the presence of failure or abnormal operation of the wheel bearing according to one embodiment of the present disclosure.

As illustrated in FIG. 7, in order to diagnose the failure of the wheel bearing according to one embodiment of the present disclosure, acceleration information is detected by the sensing part (acceleration sensor) mounted to one side of the wheel or the wheel bearing (S100). At this time, the acceleration sensor may be configured to measure acceleration while rotating together with the wheel bearing according to the rotation of the wheel bearing. The acceleration sensor may be configured to detect acceleration in at least one of a first direction extending radially from a rotational central axis of the wheel bearing and a second direction perpendicular to the first direction on a plane perpendicular to the rotational central axis.

When the acceleration information is detected by the acceleration sensor in this manner, the detected acceleration signal may be separated into a base signal and a vibration signal in a signal separation step S200. The base signal may be used to calculate speed information or the like based on the detected acceleration information (for example, the acceleration information illustrated in FIG. 5 may mean the base signal), and the vibration signal may be used to diagnose the presence of failure or abnormal operation of the wheel bearing.

Specifically, the base signal may be used to calculate the speed information (and/or rotational frequency information) in the manner described above with reference to FIGS. 4 and 5 (S300) and calculate a defect frequency band (S400). Noise included in the vibration signal may be removed through data pre-processing, such as a signal filtering, a signal smoothing or the like (S500). Subsequently, a frequency analysis is performed to diagnose failure diagnosis (S600).

In the meantime, when basic data required for performing the failure diagnosis is collected through the above-described steps, a failure diagnosis step (S700) of determining the presence or absence of failure or abnormal operation of the wheel bearing may be performed based on the collected basic data. The diagnosis result may be displayed on an external display device or the like.

According to one embodiment of the present disclosure, in the defect diagnosis step S700 of determining the presence or absence of failure or abnormal operation of the wheel bearing, for example, when a frequency band where a peak signal is generated in the vibration signal coincides with a defect frequency band calculated from the base signal, it is determined that the failure of the wheel bearing is present, whereas when the frequency bands do not coincide with each other, it is determined that the operational state of the wheel bearing is normal.

The above-described diagnosis process illustrated in FIG. 7 is an example for schematically explaining the process of diagnosing the failure of the wheel bearing according to one embodiment of the present disclosure. However, the diagnosis method according to one embodiment of the present disclosure is not necessarily limited thereto. The wheel bearing diagnosis method according to one embodiment of the present disclosure may diagnose the presence of failure or abnormal operation of the wheel bearing in a manner different from the diagnosis process illustrated in FIG. 7.

For example, the steps of the diagnosis process illustrated in FIG. 7 are shown and described in a time-series manner, but some of the steps of the diagnosis process illustrated in FIG. 7 may be performed in a simultaneous manner or in another sequential manner. In addition, some of the steps of the diagnosis process may be omitted, or additional steps may be added and performed in the diagnosis process.

While the present disclosure has been described above by way of particular features such as specific components and the like, and exemplary embodiments, these embodiments are provided to further facilitate overall understanding of the present disclosure, and the present disclosure is not limited thereto. Various modifications and variations may be made from the above descriptions by those skilled in the art.

Therefore, the spirit of the present disclosure should not be limited to the above-described embodiments, and not only the append claims but also all those modified equally or equivalently to the claims are intended to fall within the scope of the spirit of the present disclosure.

### EXPLANATION OF REFERENCE NUMERALS

10: wheel bearing for vehicle
100: diagnosis device
100a: sensing device
100b: diagnosis device
110: sensing part (acceleration sensor)
120: diagnosis part
130: storage part
140: display part
150: first input/output part
160: second input/output part

What is claimed is:

1. A method for diagnosing the presence of failure or abnormal operation of a wheel bearing, the method comprising:
an acceleration detection step of detecting acceleration information by an acceleration sensor mounted to a rotational central axis of the wheel bearing or at a position radially spaced apart from the rotational central axis and configured to rotate together with the wheel bearing;
a speed calculation step of calculating speed information based on the acceleration information detected by the acceleration sensor; and
a diagnosis step of diagnosing the wheel bearing based on the acceleration information detected by the acceleration sensor and the speed information calculated from the acceleration information,
wherein in the acceleration detection step, the acceleration sensor is configured to collect the acceleration information in at least one of a first direction extending radially from the rotational central axis of the wheel bearing and a second direction perpendicular to the first direction on a plane perpendicular to the rotational central axis of the wheel bearing.

2. The method of claim 1, wherein the acceleration sensor outputs the acceleration information in the at least one of the first direction and the second direction as a sinusoidal signal according to the rotation of the wheel bearing.

3. The method of claim 2, wherein the speed information calculated based on the acceleration information detected by the acceleration sensor is calculated in consideration of a time taken to form one-cycle of the sinusoidal signal outputted from the acceleration sensor.

4. The method of claim 3, further comprising: a signal separation step of separating a signal of the acceleration information into a base signal and a vibration signal between the acceleration detection step and the speed calculation step.

5. The method of claim 4, wherein in the speed calculation step, the speed information is calculated based on the base signal.

6. The method of claim 5, wherein in the diagnosis step, the diagnosis of the wheel bearing is performed based on the vibration signal.

7. The method of claim 6, wherein the diagnosis step is configured to determine that the failure or abnormal operation of the wheel bearing is present when a frequency band where a peak signal is generated in the vibration signal coincides with a defect frequency band calculated from the base signal.

8. The method of claim 7, further comprising: a warning step of displaying the diagnosis result to the outside when it is determined that the failure or abnormal operation of the wheel bearing is present in the diagnosis step.

9. The method of claim 1, wherein the acceleration sensor is configured to be detachably mounted to one side of a wheel mounted to the wheel bearing so as to detect the acceleration information.
